(19) United States
(12) Patent Application Publication
(10) Pub. No.: US 2024/0169406 A1
(43) Pub. Date: May 23, 2024

(54) COMPUTER-DRIVEN INTERLINKED REAL ASSET MODIFICATION INFRASTRUCTURE

(71) Applicant: ReUp IP, LLC, Lewes, DE (US)

(72) Inventors: Ryan Alan Sawchuk, Austin, TX (US); Jean Baptiste David Jacquot, Austin, TX (US)

(21) Appl. No.: 17/989,878

(22) Filed: Nov. 18, 2022

(51) Int. Cl. G06Q 30/06; G06Q 50/16

(52) U.S. Cl. CPC G06Q 30/0621; G06Q 30/0641; G06Q 50/16

(57) ABSTRACT

Briefly, example methods, apparatuses, and/or articles of manufacture may be implemented to modify a real asset. A method may include forming, via one or more computer processors coupled to at least one memory device, a group of digitized parameters representing the real asset. The method may additionally include receiving, via a graphical user interface coupled to the one or more computer processors, specified modifications to the real asset and storing, in the at least one memory device, binary digits corresponding to an as-is value of the real asset, binary digits corresponding to an estimate of resources allocated to modify the real asset, and an estimated value of the real asset that is to include the specified modifications. The method may further include computing, based, at least in part, on the estimate of the resources via the one or more computer processors, an amount of a financial resource premium that permits a first entity to procure the real asset at the as-is value and forming a record of materials and/or material specifications based, at least in part, on the specified modifications to the real asset.

### BACKGROUND

### 1. Field

The present disclosure relates generally to computer modeling, computer-aided design, modification, and/or customization of real assets via a graphical user interface, and determination of a financial resource premium, which may be payable responsive to completion of such modifications and/or customizations of the real asset.

### 2. Information

For many people, the purchase of a real asset, which may include real estate, such as a single-family home, townhouse, condominium, or the like, represents a significant and inspiring event in a person's life. In many instances, purchase of such real assets symbolizes a progression in a person's life from adolescence to adulthood. Such an event may be followed, for example, by marriage, raising children, as well as an overall desire and ability to assume increased responsibility and to fully engage in family and community life.

In addition, the purchase of a real asset may bring about significant, long-term financial benefits. For example, purchase of certain real assets, such as single-family homes in particular, represent relatively stable investments that generally, over the long-term, increase in value. Such steady increases in value of a real asset may form a significant portion of an individual's or a couple's long-term wealth-building strategy, which may help to ensure that the individual or couple are able to retire “comfortably,” for example. In addition, steady increases in value of a real asset may permit a homeowner to establish, for example, a home equity line of credit, in which credit may be available at an interest rate much lower than other credit sources, such as credit cards. Accordingly, in response to a homeowner's needing to purchase an automobile, for example, the homeowner may access the home equity line of credit, thus permitting the homeowner to finance the purchase at an interest rate lower than those offered by, for example, an automobile dealer.

However, a real asset may, over a period of several years for example, undergo certain types of deterioration, such as normal wear and tear, damage due to fire, flood, accident, etc. In addition, a real asset may appear to be out-of-date as various stylistic or aesthetic aspects of the real asset may appear old-fashioned when compared, for example, to newly-constructed real assets. Thus, in such instances, a homeowner may wish to customize or modify a real asset so that the asset can be offered for sale at an increased price. Such modifications and/or customizations may include remodeling a kitchen and/or bathroom, which may involve an expenditure of, for example, thousands, tens of thousands, or even hundreds of thousands of dollars. Accordingly, it may be appreciated that despite a tendency for a real asset to increase in value over time, a homeowner may find themselves in a quandary in which although the homeowner can be assured that the real asset has increased in value; the homeowner may not have immediate access to sufficient capital to modify or to customize the asset so as to command the desired premium price. Thus, it may be appreciated that development of approaches for cost-effectively assisting homeowners, for example, in upgrading, modifying, and/or customizing real assets continues to be an active area of investigation.

### SUMMARY

One general aspect includes a method for customizing a real asset, including forming, via one or more computer processors coupled to at least one memory device, a group of digitized parameters representing the real asset. The method also includes receiving, via a graphical user interface coupled to the one or more computer processors, specified modifications to the real asset. The method also includes storing, in the at least one memory device, binary digits corresponding to an as-is value of the real asset, binary digits corresponding to an estimate of resources allocated to modify the real asset, and an estimated value of the real asset that is to include the specified modifications. The method also includes computing, based, at least in part, on the estimate of the resources via the one or more computer processors, an amount of a financial resource premium that permits a first entity to procure the real asset at the as-is value. The method also includes forming a record of materials and/or material specifications based, at least in part, on the specified modifications to the real asset.

In particular embodiments, the method may additionally include computing a fraction of the amount of the financial resource premium provided to the first entity responsive to a second entity procuring the real asset. In particular embodiments, the group of digitized parameters representing the real asset correspond to construction parameters of the real asset. In particular embodiments, the construction parameters of the real asset correspond to at least one of: a floor plan, a type of flooring in one or more sections of the real asset, a roof type, cabinetry parameters, installed appliance parameters, countertop parameters, outside landscaping parameters, kitchen fixture parameters, bathroom fixture parameters, interior wall coloring, and exterior coloring. In particular embodiments, the real asset corresponds to a real estate asset. In particular embodiments, the digitized parameters correspond to one or more computer-aided design files. In particular embodiments, the method may further include transmitting the record of materials and/or material specifications to a contracting entity to modify or tailor the real asset in accordance with the specified modifications. In particular embodiments computing, based, at least in part, on the estimate of the resources further includes initiating a smart contract for an amount based, at least in part, on the amount of the financial resource premium amount. In particular embodiments, the amount of the smart contract corresponds to the financial resource premium amount. In particular embodiments, the graphical user interface coupled to the one or more computer processors includes an application program interface operating on a mobile communications device. In particular embodiments, the first entity may correspond to a real estate flipper.

Another general aspect includes one or more computer processors coupled to at least one memory device to form a group of digitized parameters to represent a real asset. The system also includes a graphical user interface, coupled to the one or more computer processors, to permit a user to specify one or more modifications to the real asset, wherein the at least one memory device is to store binary digits corresponding to an as-is value of the real asset, an estimate of resources allocated to modify the real asset and an estimated value of the real asset that is to include the specified modifications. The one or more computer processors is to compute based, at least in part, on the estimate of the financial resources, a financial resource premium that permits a first entity to procure the real asset at the as-is value, and wherein the one or more computer processors is additionally to form a record of materials and/or material specifications based, at least in part, on the specified modifications to the real asset.

In particular embodiments, the graphical user interface operates to present a plurality of options for user-selectable material parameters and/or material specifications to the user via an application programming interface operating on a mobile cellular device. In particular embodiments, the graphical user interface operates to interact with a computer-aided design module, which operates to model of a certain aspects of the real asset. In particular embodiments, the one or more computer processors coupled to the at least one memory device is additionally to generate, without user input, a listing of material specifications and/or contractor work descriptions responsive to communicating with the computer-aided design module. In particular embodiments, the financial resource premium is based, at least in part, on output signals from the computer-aided design module.

Another general aspect includes a non-transitory storage medium having computer-readable instructions encoded thereon, which, when executed by a processor coupled to a memory device, are operable to form, via one or more computer processors coupled to at least one memory device, a group of digitized parameters representing a real asset. The computer-readable instructions are to also obtain, via a graphical user interface coupled to the one or more computer processors, specified modifications to the real asset. The computer-readable instructions are also to store, in the at least one memory device, binary digits corresponding to an as-is value of the real asset, binary digits corresponding to an estimate of resources allocated to modify the real asset in accordance with predetermined modifications, and an estimated value of the real asset that is to include the specified modifications. The computer-readable instructions are also to compute, based, at least in part, on the estimate of the resources via the one or more computer processors, an amount of a financial resource premium that permits a first entity to procure the real asset at the as-is value. The computer-readable instructions are also to form a record of materials and/or material specifications based, at least in part, on the specified modifications to the real asset.

In particular embodiments, the computer-readable instructions are additionally operable to compute a fraction of the amount of the financial resource premium provided to the first entity responsive to a second entity procuring the real asset. In particular embodiments, the group of digitized parameters representing the real asset correspond to construction parameters of the real asset. In particular embodiments, the construction parameters of the real asset correspond to at least one of: a floor plan, a type of flooring in one or more sections of the real asset, a roof type, cabinetry parameters, installed appliance parameters, countertop parameters, outside landscaping parameters, kitchen fixture parameters, bathroom fixture parameters, interior wall coloring, and/or exterior coloring. In particular embodiments, the instructions are additionally operable to form a record of materials and/or material specifications, and to transmit the record of the materials and/or the material specifications to a contracting entity.

### BRIEF DESCRIPTION OF THE DRAWINGS

Claimed subject matter is particularly pointed out and distinctly claimed in the concluding portion of the specification. However, both as to organization and/or method of operation, features, and/or advantages thereof, it may best be understood by reference to the following detailed description if read with the accompanying drawings in which:

FIG. 1 is a diagram of a communications infrastructure that includes both wireless and wireline communications devices and components, according to various embodiments.

FIG. 2A is a diagram of a subscriber in possession of a communications device, which permits the subscriber to customize or modify a real asset, according to an embodiment.

FIG. 2B is a diagram of a user interacting with a graphical user interface of a communications device prior to selection of design aspects of a kitchen of a real asset, according to an embodiment.

FIG. 2C is a diagram of a user interacting with a graphical user interface of a communications device after selection of design aspects of a kitchen of a real asset, according to an embodiment.

FIG. 3 is a flowchart for a method of customizing and/or modifying a real asset, wherein such customizations/modifications are interlinked with a real asset modification infrastructure, according to an embodiment.

FIG. 4 is a flowchart for method for computer-driven real asset customizations and/or modifications which are interlinked with a real asset modification infrastructure, according to an embodiment.

FIG. 5 is a diagram showing a computing environment, according to an embodiment.

Reference is made in the following detailed description to the accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim.

### DETAILED DESCRIPTION

Throughout this specification, references to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases are not necessarily intended to refer to the same implementation and/or embodiment or to any one particular implementation and/or embodiment. Furthermore, it is to be understood that particular features, structures, characteristics, and/or the like described, are capable of being combined in various ways in one or more implementations and/or embodiments and, therefore, are within intended claim scope. In general, for the specification of a patent application, these and other issues have a potential to vary in a particular context of usage. In other words, throughout the disclosure, particular context of description and/or usage provides guidance regarding reasonable inferences to be drawn; however, likewise, the term “in this context” in general without further qualification refers at least to the context of the present patent application.

As previously alluded to, in many instances the purchase of a real asset, which may include real estate (e.g., a single- or multi-family home, a townhouse, a condominium, etc.) represents a significant event in our a person's life. In many instances, purchase of such real assets symbolize progression of a person's life, such as from adolescence to adulthood. Such an event may be followed, for example, by marriage, raising children, as well as an overall desire and ability to assume increasing responsibility and to fully engage in family and community life. Purchase of a real asset may be emblematic of a person's desire to remain and/or to become attached to a certain neighborhood or region, a certain group of individuals, a certain climate, and so forth.

Also as previously discussed, the purchase of a real asset may be instrumental in achieving a person's long-term financial goals. For example, purchase of certain real assets, such as single-family homes in particular, represent relatively stable investments that generally, over the long-term, predictably increase in value. Such steady and perhaps predictable increases in value of a real asset may form a significant portion of an individual's, couple's or family's long-term wealth-building strategy, which may help to ensure that the individual or couple are able to retire from full-time work with some degree of comfort, for example. In addition, steady, predictable increases in value of a real asset may permit a homeowner to obtain, for example, a home equity line of credit, which may enable resources (e.g., financial resources) to be available at an interest rate much lower than that of other sources of credit, such as credit cards and personal loans. Accordingly, in response to a homeowner's needing to purchase an automobile or to finance remodeling of a portion of the real asset, for example, the homeowner may be able to access the home equity line of credit, thus permitting the homeowner to finance the purchase at an interest rate lower than those offered by other sources of credit.

However, a real asset may, perhaps over a period of several years, undergo certain types of deterioration, which may result from normal wear and tear, damage due to fire, flood, accident, etc. In addition, certain stylistic aspects of a real asset may appear to be out-of-date as such aspects may appear old-fashioned when compared, for example, to newly-constructed real assets. Thus, in such instances, a homeowner may wish to modify or to customize a real asset so that the asset can be offered for sale at a premium price. Such modifications and/or customizations may include remodeling a kitchen and/or bathroom portion of a real asset, which may require the homeowner to expend, for example, thousands of dollars, tens of thousands of dollars, or even greater amounts. Accordingly, it may be appreciated that despite a tendency for a real asset to increase in value over time, a homeowner may find themselves in a predicament in which, although the homeowner is relatively certain that the asset has increased in value to a premium price, the homeowner may not have immediate access to sufficient capital to customize or modify the real asset so as to command that premium price.

In one scenario, for example, a homeowner may wish to upgrade to a larger, second single-family home 10 years, for example, after the purchase of a first single-family home. However, although the first single-family home may have appreciated significantly in value, perhaps by 100% or more, the homeowner may not be in a position, such as a financial position, to perform modifications and/or customizations that could sufficiently increase the value of the home. Such scenarios may represent a source of frustration in which a homeowner may possess or have access to a valuable real asset but without immediate access to the funds to bring the real asset to a desired selling condition. Thus, in some instances, in an attempt to increase the value of the real asset, the homeowner may attempt to obtain a personal loan or may attempt to finance modifications/customizations to a real asset utilizing bank-issued credit cards both of which, for example, may carry an undesirably high interest rate. Alternatively, or in addition to, the homeowner may attempt to perform various customizations and/or modifications without professional assistance which may represent an inefficient use of the homeowner's time and may result in modifications and/or customizations that are not of the highest possible quality.

Thus, in particular embodiments, a homeowner, or other individual, or group of individuals, having an interest (e.g., a financial interest) in a particular real asset, may be assisted by computer-driven real asset customization that is linked to financial resource allocation. In certain embodiments, for example, a homeowner may utilize a system comprising one or more computer processors coupled to at least one memory device, to form a group of digitized parameters representing the real asset. In particular embodiments, the group of digitized parameters representing the real asset may bring about formation of a computer model of a real asset. In response to formation of a computer (or virtual) model of a real asset, a homeowner, for example, may modify certain parameters of a computer or virtual model of the real asset in a manner that facilitates virtual or computer-aided inspection of the model of the real asset responsive to such modifications. For example, following upload of parameters of a real asset into a computer memory, a homeowner, for example, may be capable of substituting existing walls with differently-colored walls, removal and/or addition of a wall, substituting existing flooring with different flooring (e.g., new carpet, or other flooring) in a manner that permits the homeowner to quickly review (e.g., in a computer or virtual domain) the effect of such substitutions. In particular embodiments, a processor coupled to at least one memory device may permit a homeowner, for example, to insert dozens, hundreds, or even thousands of customizations and/or modifications to a real asset in a manner that permits the homeowner to review a complete ensemble of changes made to the real asset.

Particular embodiments may additionally benefit certain real estate investors engaged in “flipping” of real assets. In this context, the term “flip” or “flipping” refers to the purchasing, procurement, or otherwise securing of a real asset with an intent of replacing and/or modifying particular aspects of the real asset with different (e.g., customized) and/or updated aspects and reselling the real asset for a price that is greater than the price paid by the flipper to obtain the real asset. In this context a “flipper” corresponds to a homeowner, even though such homeowner has, perhaps, owned a real asset for a relatively short period of time, such as a period of less than six months. For example, in this context, flipping a real asset may include purchasing or procuring of a real asset and removing old and/or outdated aspects, such as flooring, countertops, plumbing fixtures, walls, doors, baseboards, moldings, for example, and replacing the old and/or outdated aspects with different, modified, and/or customized aspects. Thus, in one instance, flipping of an aging real asset may involve purchasing of the aging real asset, removing carpets, removing/adding walls, removing/replacing doors, remediating structural features such as foundations, loadbearing structural elements, removing/replacing countertops, removing and replacing one or more plumbing fixtures, and so forth. At a point during a flipping process, such as after remediating any structural aspects of a real asset, an investor or other entity may obtain design parameters from a prospective buyer or from the flipper, just as examples, which may specify aspects of the real asset that are to replace any removed structural aspects, plumbing fixtures, flooring, etc. In one particular embodiment, flipping of a real estate asset may involve bringing a real asset to a “structurally sound” state, which refers, in this context, to a state of a real asset at which foundations, roofs, loadbearing walls, subflooring, etc., has been remediated. In response to a real asset being brought to a structurally sound estate, selection of various design parameters of the real asset may begin.

In particular embodiments, a processor coupled to at least one memory device may access one or more databases, such as real asset databases, which may provide an estimate of an “as-is” value of a real asset. In this context, the term “as-is” refers to the condition of a real asset in its current state, such as without any substantial customizations and/or modifications. Accordingly, for example, a real asset in an “as-is” condition refers to the condition of the real asset, such as without substantial repair, repainting, re-flooring, re-roofing, and so forth. To determine or estimate an “as-is” value of a real asset, a homeowner may consult one or more real-asset databases. A real asset database may utilize a variety of input signals, such as recent real estate transactions in the vicinity of a real asset, tax records, satellite imagery, street maps, and a host of signal inputs to determine and/or estimate an “as-is” value.

In particular embodiments, in response to a homeowner or flipper, just as examples of, selecting to modify a real asset, a processor coupled to the at least one memory device may, operating under the direction of a computer-aided design program operating responsive to an executable set of instructions, provide estimates of resources (e.g., financial resources) consumed in providing the selected customizations and/or modifications. In one example, responsive to a homeowner selecting to replace carpet or other type of flooring in a portion of a real asset, a resources database may estimate or assign a particular monetary cost or amount to obtain and install the selected flooring. In another example, responsive to a homeowner selecting to repaint one or more rooms or other portions of a real asset, a resources database, such as a financial resources database, may estimate or assign a particular monetary cost to obtain and to apply sealer, primer, and paint, as well as determining or estimating other material or labor-related cost elements associated with other aspects of re-coloring the one or more portions of the real asset.

Responsive to accessing one or more databases to provide an estimate of an “as-is” value of a real asset, as well as providing signals relating to resources (e.g., financial resources) to perform various customizations and/or modifications to the real asset, a computer processor coupled to at least one memory device may determine the value of the real asset that includes the requested customizations and/or modifications. Thus, in one possible example, in response to a homeowner selecting to recarpet and repaint all portions of a real asset, a computer processor coupled to at least one memory device may compute an estimate of the real asset value after such recarpeting/repainting. A computer processor coupled to at least one memory device may compute estimates of a real asset value after numerous other customizations and/or modifications, and claimed subject matter is not limited in this respect.

In particular embodiments, based, at least in part, on an estimate of a real asset resulting from customizations and/or modifications, a computer processor coupled to at least one memory device may compute a “financial resource premium.” In this context, a financial resource premium refers to an instrument, such as a call option premium, which provides a first entity (e.g., an investor), for example, with a right (e.g., an option) to purchase a percentage of the real asset within a specified period of time. In certain embodiments, the amount of the financial resource premium may be provided to the current homeowner (e.g., a current resident or a flipper), who may then be in a position to complete (such as with the assistance of one or more contracting entities) desired customizations and/or modifications. Following completion of customizations and/or modifications, the homeowner may then be in a position to sell the real asset for a desired (e.g., a premium) price. Following sale of the real asset, the seller may return the portion of the value of the real asset back to the investor. Examples of the financial resource premium (e.g., the call option premium), which permits a first entity (e.g., an investor) to purchase a percentage of the real asset, are discussed further hereinbelow. It may be appreciated that numerous scenarios for assessing financial resource premiums (e.g., call options) percentage of ownership by an investor (e.g., 10%, 20%, 50%, 60%, etc.) are possible, and claimed subject matter is not limited in these respects.

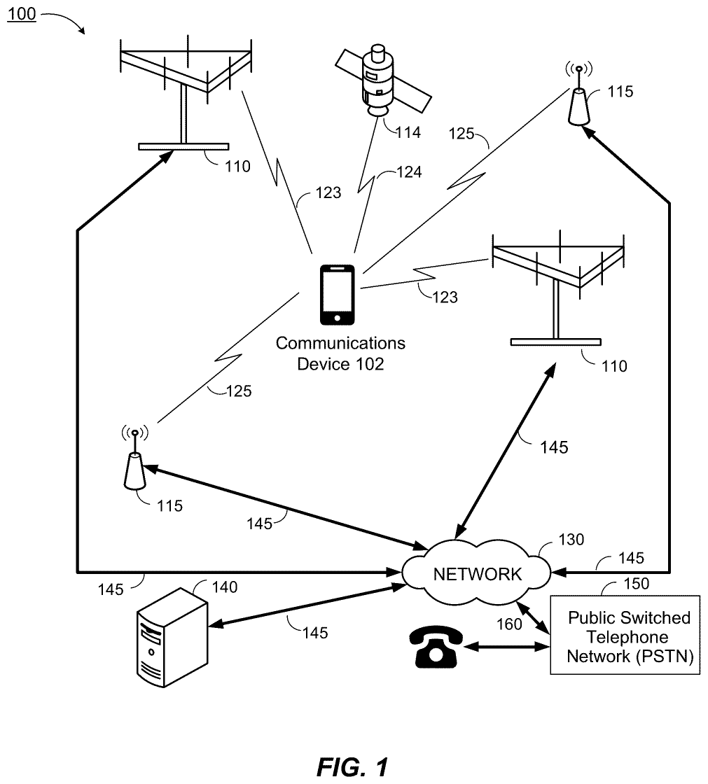

Prior to describing further details relevant to computer-driven real asset modification and financial resource allocation, a communications infrastructure that permits user interaction with a mobile communications device or other type of communications device is first described. Thus, FIG. 1 is a diagram of a communications infrastructure that includes both wireless and wireline communications devices as well as components that facilitate such wireless and wireline communications, according to various embodiments. A communications infrastructure may permit a user, such as a homeowner, flipper, investor, etc., to utilize a mobile communications device (e.g., a mobile cellular telephone) to select and/or specify customizations and/or modifications to a real asset, as discussed hereinabove. In FIG. 1, corresponding to embodiment 100, mobile communications device 102 corresponds to a device designed primarily to conduct communications via cellular wireless, Vol P, or wireline means, such as to provide telephone communications, texting, web browsing, and so forth. In the embodiment of FIG. 1, mobile communications device 102 may transmit radio signals to, and receive radio signals from, a wireless communications network. In an example, mobile communications device 102 may communicate with a cellular communications network by transmitting wireless signals to, and/or receiving wireless signals from, a cellular transceiver 110, which may comprise a wireless base transceiver subsystem, a Node B or an evolved NodeB (eNodeB), over wireless communication link 123. Similarly, mobile communications device 102 may transmit wireless signals to, and/or receive wireless signals from, local transceiver 115 over wireless communication link 125. A local transceiver 115 may comprise an access point (AP), femtocell, Home Base Station, small cell base station, Home Node B (HNB) or Home eNodeB (HeNB) and may provide access to a wireless local area network (WLAN, e.g., IEEE 802.11 network), a wireless personal area network (WPAN, e.g., Bluetooth® network) or a cellular network (e.g. an LTE network or other wireless wide area network, such as those discussed herein). Of course, it should be understood that these are merely examples of networks that may communicate with a mobile device over a wireless link, and claimed subject matter is not limited in this respect. In particular embodiments, cellular transceiver 110, local transceiver 115, satellite 114, and PSTN 150 represent touchpoints that permit mobile communications device 102 to interact with network 130.

Examples of network technologies that may support wireless communication link 123 are GSM, Code Division Multiple Access (CDMA), Wideband CDMA (WCDMA), Long Term Evolution LTE), High Rate Packet Data (HRPD). GSM, WCDMA, and LTE are technologies defined by 3GPP. CDMA and HRPD are technologies defined by the 3^{rd} Generation Partnership Project 2 (3GPP2). WCDMA is also part of the Universal Mobile Telecommunications System (UMTS) and may be supported by an HNB. Cellular transceivers 110 may comprise deployments of equipment providing subscriber access to a wireless communications network for a service (e.g., under a service contract). In the embodiment of FIG. 1, a cellular transceiver 110 may perform functions of a cellular base station in servicing subscriber devices within a cell determined based, at least in part, on a range at which the cellular transceiver 110 is capable of providing access service. Examples of radio technologies that may support wireless communication link 125 are IEEE 802.11, BT and LTE.

In a particular implementation, cellular transceiver 110 and local transceiver 115 may communicate with server 140, such as by way of network 130 via communication links 145. Here, network 130 may comprise any combination of wired or wireless links and may include cellular transceiver 110 and/or local transceiver 115 and/or server 140. In a particular implementation, network 130 may comprise Internet Protocol (IP) or other infrastructure capable of facilitating communication between mobile communications device 102 at a call source and server 140 through local transceiver 115 or cellular transceiver 110. In an embodiment, network 130 may also facilitate communication between mobile communications device 102, server 140 and a PSTN 150, for example through communications link 160. In another implementation, network 130 may comprise a cellular communication network infrastructure such as, for example, a base station controller or packet based or circuit based switching center (not shown) to facilitate mobile cellular communication with mobile communications device 102. In a particular implementation, network 130 may comprise local area network (LAN) elements such as WiFi APs, routers and bridges and may, in such an instance, comprise links to gateway elements that provide access to wide area networks such as the Internet. In other implementations, network 130 may comprise a LAN and may or may not involve access to a wide area network but may not provide any such access (if supported) to mobile communications device 102. In some implementations, network 130 may comprise multiple networks (e.g., one or more wireless networks and/or the Internet). In one implementation, network 130 may include one or more serving gateways or Packet Data Network gateways. In addition, one or more of server 140 may comprise an E-SMLC, a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs) of network 130.

In particular embodiments, communications between mobile communications device 102 and cellular transceiver 110, satellite 114, local transceiver 115, and so forth may occur utilizing signals communicated across wireless or wireline communications channels. Accordingly, the term “signal” may refer to communications utilizing propagation of electromagnetic waves or electronic signals via a wired or wireless communications channel. Signals may be modulated to convey messages utilizing one or more techniques such as amplitude modulation, frequency modulation, binary phase shift keying (BPSK), quaternary phase shift keying (QPSK) along with numerous other modulation techniques, and claimed subject matter is not limited in this respect. Accordingly, as used herein, the term “messages” refers to parameters, such as binary signal states, which may be encoded in one or more signals using one or more of the above-identified modulation techniques.

In particular implementations, and as discussed below, mobile communications device 102 may comprise circuitry and processing resources capable of obtaining location related measurements (e.g. for signals received from GPS or other Satellite Positioning System (SPS) satellites 114), cellular transceiver 110 or local transceiver 115 and possibly computing a position fix or estimated location of mobile communications device 102 based on these location related measurements. In some implementations, location related measurements obtained by mobile communications device 102 may be transferred to a location server such as an enhanced serving mobile location center (E-SMLC) or SUPL location platform (SLP) (e.g. which may comprise a server, such as server 140) after which the location server may estimate or determine an estimated location for mobile communications device 102 based on the measurements. In the presently illustrated example, location related measurements obtained by mobile communications device 102 may include measurements of signals 124 received from satellites belonging to an SPS or Global Navigation Satellite System (GNSS) such as GPS, GLONASS, Galileo or Beidou and/or may include measurements of signals (such as 123 and/or 125) received from terrestrial transmitters fixed at known locations (e.g., such as cellular transceiver 110).

Mobile communications device 102 or a separate location server may obtain a location estimate for mobile communications device 102 based on location related measurements using any one of several position methods such as, for example, GNSS, Assisted GNSS (A-GNSS), Advanced Forward Link Trilateration (AFLT), Observed Time Difference Of Arrival (OTDOA) or Enhanced Cell ID (E-CID) or combinations thereof. In some of these techniques (e.g. A-GNSS, AFLT, and OTDOA), pseudoranges or timing differences may be measured at mobile communications device 102 relative to three or more terrestrial transmitters fixed at known locations or relative to four or more satellites with accurately known orbital data, or combinations thereof, based at least in part, on pilots, positioning reference signals (PRS) or other positioning related signals transmitted by the transmitters or satellites and received at mobile communications device 102. Here, server 140 may be capable of providing positioning assistance data to mobile communications device 102 including, for example, information regarding signals to be measured (e.g., signal timing), locations and identities of terrestrial transmitters and/or signal, timing and orbital information for GNSS satellites to facilitate positioning techniques such as A-GNSS, AFLT, OTDOA and E-CID. For example, server 140 may comprise an almanac to indicate locations and identities of cellular transceivers and/or local transceivers in a particular region or regions such as a particular venue, and may provide information descriptive of signals transmitted by a cellular base station or AP such as transmission power and signal timing. In the case of E-CID, mobile communications device 102 may obtain measurements of signal strengths for signals received from cellular transceiver 110 and/or local transceiver 115 and/or may obtain a round trip signal propagation time (RTT) between mobile communications device 102 and a cellular transceiver 110 or local transceiver 115. A mobile communications device 102 may use these measurements together with assistance data (e.g. terrestrial almanac data or GNSS satellite data such as GNSS Almanac and/or GNSS Ephemeris information) received from server 140 to determine a location estimate for mobile communications device 102 or may transfer the measurements to server 140 to perform the same determination. A call from mobile communications device 102 may be routed, based on the location of mobile communications device 102, and connected to PSTN 150, for example, via wireless communication link 123 and communications link 160.

A mobile device at a call source (e.g., mobile communications device 102 of FIG. 1) may be referred to by any name corresponding to a cellphone, smartphone, laptop, tablet, PDA, tracking device or some other portable or movable device. Typically, though not necessarily, a mobile device may support wireless communication such as using GSM, WCDMA, LTE, CDMA, HRPD, WiFi, BT, WiMax, etc. A mobile device may also support wireless communication using a wireless LAN (WLAN), DSL or packet cable for example. A mobile device may comprise a single entity or may comprise multiple entities such as in a personal area network in which a user may employ audio, video and/or data I/O devices and/or body sensors and a separate wireline or wireless modem. An estimate of a location of a mobile device (e.g., mobile communications device 102) may be referred to as a location, location estimate, location fix, fix, position, position estimate or position fix, and may be geographic, thus providing location coordinates for the mobile device (e.g., latitude and longitude) which may or may not include an altitude component (e.g., height above sea level, height above or depth below ground level, floor level or basement level).

Mobile communications device 102 may comprise an embedded sensor suite which may, for example, include inertial sensors and environment sensors. Inertial sensors of mobile communications device 102 may comprise, for example accelerometers (e.g., collectively responding to acceleration of mobile communications device 102 in and x-direction, a y-direction, and a z-direction). Mobile communications device 102 may further include one or more gyroscopes or one or more magnetometers (e.g., to support one or more compass applications). Environment sensors of mobile communications device 102 may comprise, for example, temperature sensors, barometric pressure sensors, ambient light sensors, camera imagers, microphones, just to name few examples. Sensors of mobile communications device 102 may generate analog or digital signals that may be stored in utilizing one or more memory locations internal to device 102 in support of one or more applications such as, for example, applications collecting or obtaining biometric attributes of a user (e.g., a subscriber) of mobile communications device 102.

The architecture of the cellular communications network described in relation to FIG. 1 may comprise a generic architecture that is capable of accommodating a variety of outdoor and indoor location solutions including the standard SUPL user plane location solution defined by the Open Mobile Alliance (OMA) and standard control plane location solutions defined by 3GPP and 3GPP2. For example, server 140 may function as (i) a SUPL location platform to support the SUPL location solution, (ii) an E-SMLC to support the 3GPP control plane location solution with LTE access on wireless communication link 123 or 125, or (iii) a Standalone Serving Mobile Location Center (SAS) to support the 3GPP Control Plane Location solution for UMTS.

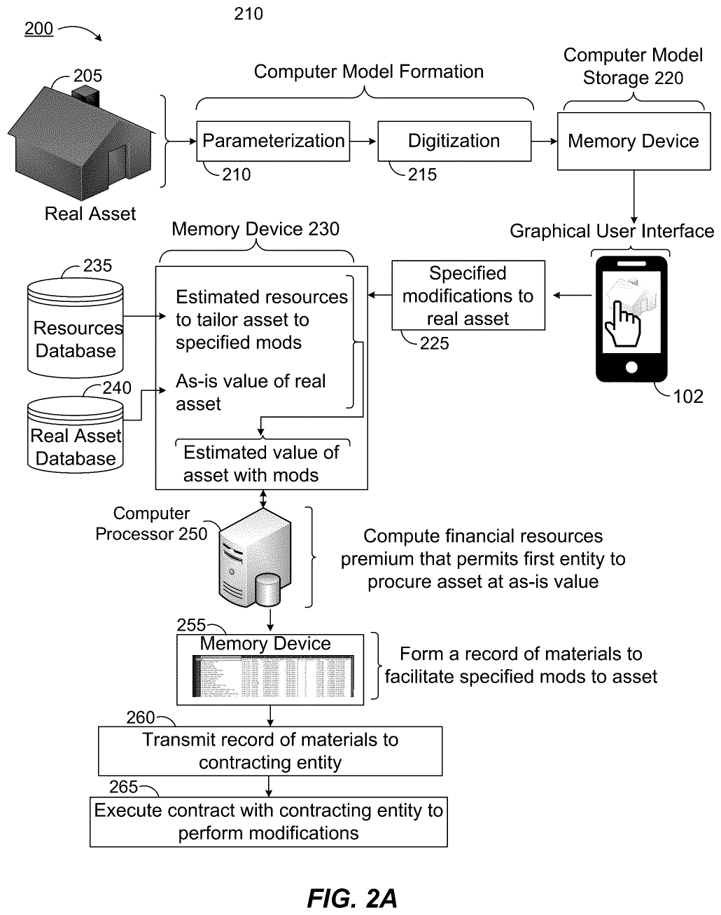

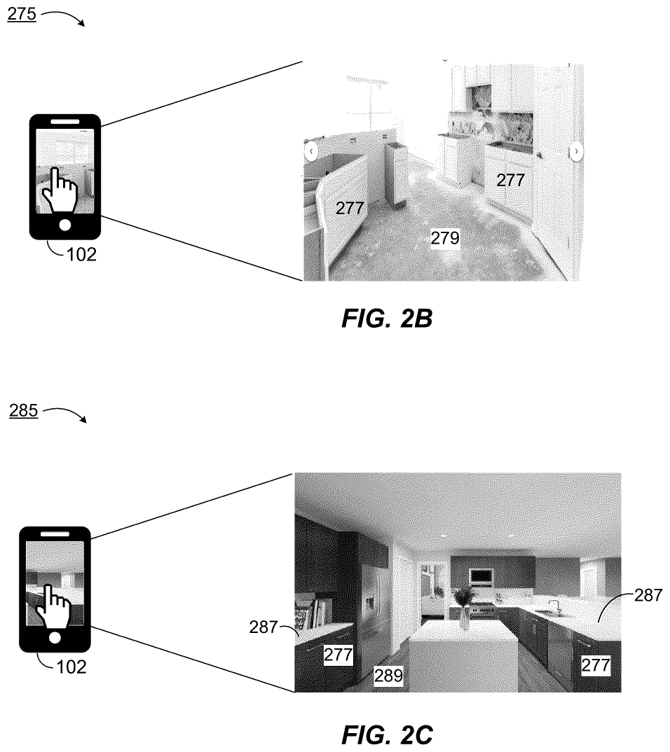

FIG. 2A is a diagram of a subscriber in possession of a communications device (e.g., communications device 102), which permits a user (e.g., a homeowner or a flipper) to customize or modify a real asset, according to an embodiment 200. In embodiment 200, real asset 205 corresponds to an article of real estate, which may include a single-family home, a multi-family home, a condominium, a townhouse, or any other asset that can be purchased, sold, leased, sublet, rented, and so forth. Thus, although real asset 205 is shown as comprising, for example, a single-family, real asset 205 may comprise any type of dwelling, and claimed subject matter is not limited in this respect. Real asset 205 may be owned, at least for certain duration, by one or more individuals living or dwelling in the real asset, or may be owned by an investor or flipper, who has purchased the real asset with an intent toward reselling the real asset for a monetary amount greater than the purchase price. Aspects of real asset 205, such as the asset's physical characteristics (e.g., square footage), materials utilized in constructing real asset 205, number of stories, roof composition, flooring type, number of bathrooms (e.g., full baths, half baths, etc.), and numerous other physical characteristics may be converted to parameters for use in forming a computer model. Accordingly, as shown in FIG. 2A, real asset 205 may be “parameterized” (such as at 210) and “digitized” (such as at 215) so as to be converted to a computer model that can be operated upon by, for example, a computer-aided design software package. Following parameterization (210) and digitization (215) of real asset 205, the resulting computer model may be stored in memory, such as by way of memory device 220.

Parameterized and digitized computer representation of real asset 205 may then be manipulated, such as by way of a graphical user interface operating on mobile communications device 102. A graphical user interface may permit a user (e.g., a perspective future purchaser of the real asset or by a flipper intending to resell the real asset) to rotate an image of real asset 205, increase/decrease magnification of the image of asset 205, add or remove layers to the image of asset 205, modify color schemes of various components of asset 205, add, remove, and/or reconfigure certain walls, cabinets, countertops, and perform a host of other virtual manipulations of asset 205, and claimed subject matter is intended to embrace all possible manipulations of various aspects of asset 205. In particular embodiments, a graphical user interface operating on mobile communications device 102 may be performed utilizing a set of computer-executable instructions such as application program interface (API).

In the embodiment of FIG. 2A, customizations and/or modifications to real asset 205 in a virtual domain may be converted to a listing of specified modifications, such as at 225. In particular embodiments, a listing of specified modifications may correspond to instructions or descriptors that operate to modify selected aspects of a computer model in a virtual domain that correspond to real asset 205. Alternatively, or in addition to, specified modifications may include a group of new or different aspects of particular records of a computer model corresponding, in a virtual domain, to real asset 205. It should be noted that claimed subject matter is intended to embrace all approaches toward specifying modifications of a real asset without any significant limitations.

Listings or records, such as in the form of binary digits descriptive of specified modifications of real asset 205 may be stored within memory device 230. Memory device 230, in addition to receiving signals originating from mobile communications device 102, may also receive input signals from resources database 235. In particular embodiments, resources database 235 may provide an estimate of costs associated with construction parameters corresponding to customizations and/or modifications specified by, for example, a homeowner of real asset 205. Thus, for example, responsive to a homeowner (or flipper) selecting to re-floor a portion of real asset 205, resources database 235 may provide construction parameters, such as measurements of one or more areas to be re-floored, material type, measurements and material types for trim and molding, and so forth, to accomplish the re-flooring of the portion of the asset. In particular embodiments, resources database 235 may include construction parameters corresponding to modifications to a floor plan, modifications to a type of flooring in one or more sections of a real asset, modifications, repair and/or replacement of a roof, modifications related to cabinetry materials and labor costs, installed appliance parameters, countertop fabrication and installation, outside landscaping parameters, kitchen fixture and/or plumbing parameters, bathroom fixture and/or plumbing parameters, interior wall coloring and labor, external coloring and labor, and any number of additional construction parameters corresponding to customizations and/or modifications selected via an API operating on mobile communications device 102. Thus, in the embodiment of FIG. 2A, resources database 235 may operate to provide an indication of financial resources (e.g., material costs, labor costs, costs associated with obtaining necessary permits from local authorities, material disposal costs, etc.), which may be consumed in completing customizations and/or modifications selected via mobile communications device 102. It may be appreciated that resources database 235 may provide cost parameters for numerous additional types of modifications that may be made to aspects of real asset 205.

Computer processor 250 coupled to memory device 230 may additionally utilize input signals from real asset database 240, so as to compute an as-is value (e.g., prior to performing customizations and/or modifications). Computer processor 250 coupled to memory device 230 may further compute a financial resource premium that would allow the first entity (e.g., an investor) to purchase or procure real asset 205 from, for example, the present owner of the real asset. In particular embodiments, real asset database 240 may represent a real asset database comprising entries corresponding to hundreds, thousands, or even millions of property listings for real assets, perhaps distributed over a wide geographical area. For example, real asset database 240 may include listings of properties in the same neighborhood as real asset 205, the same area of town as real asset 205, the same city or township as real asset 205, the same county as real asset 205, the same state as real asset 205, etc. Although shown as comprising a single entity in FIG. 2A, real asset database 240 may comprise a number of databases spread over a wide area. Thus, real asset database 240 may, based on access of potentially numerous databases storing past and/or pending real estate sales in a similar township or city, county, state, etc. may be utilized to compute the as-is value of real asset 205.

Responsive to receipt of an as-is value for real asset 205, computer processor 250 may operate to compute an estimated value of asset 205 after completion of specified modifications to the asset. In particular embodiments, computation of an estimated value of asset 205 may include summing contributions of discrete modifications to a real asset and simply adding corresponding values of such modifications to the as-is value of the asset. In some instances, computer processor 250 may provide further adjustments to the as-is value of an asset in response to applying one or more weighting factors with respect to certain modifications. For example, computer processor 250 may apply a weighting factor of greater than 1.0 (e.g., 1.05, 1.10, 1.15, 1.20, 1.25, etc.) to indicate an impact of a new or remodeled kitchen on the value of real asset 205. In one possible example just for the sake of illustration, a new kitchen costing $50,000 in material and labor, may actually increase the value of real asset 205 by $55,000, $60,000, $65,000, or more or less. In other instances, computer processor 250 may apply a weighting factor of less than 1.0 (e.g., 0.75, 0.80, 0.85, 0.90, 0.95, etc.) to indicate an impact of, for example, a new swimming pool on the value of real asset 205. Thus, in one possible example just to illustrate, a new swimming pool costing $40,000 may actually increase the value of real asset 205 by a lesser number, such as $37,500, $35,000, $30,000, etc. It should be noted that claimed subject matter is intended to embrace numerous weighting factors to compute expected returns for modifications to real asset 205, and claimed subject matter is not limited in this respect.

In response to computer processor 250 computing an estimated value of an asset with specified modifications, which may include applying factors described hereinabove to estimate expected returns for certain modifications to real asset 205, processor 250 may compute a financial resource premium. In the embodiment of FIG. 2A, the financial resource premium may correspond to an amount that permits a first entity, such as an investor, to purchase the real asset at a current, as-is value. In particular embodiments, the financial resource premium corresponds to an amount allocated to perform desired modifications and/or customizations to a real asset. Computer processor 250 coupled to memory device 230 may compute a financial resource premium based, at least in part, on an estimated value of a real asset with modifications. Thus, for example, responsive to real asset 205 having an as-is value of $500,000, and responsive to computer processor 250 computing an estimated value of real asset 205 (after completion of specified modifications) of $600,000, computer processor 250 may determine the financial resource premium of $100,000 (e.g., $600,000-$500,000). In the embodiment of FIG. 2A, a financial resource premium (or portion thereof) may then be conveyed to the homeowner, or to the flipper, for example, of real asset 205 so that the homeowner or flipper, for example, can effect or bring about customizations and/or modifications to real asset 205. As described hereinbelow, the financial resource premium may be conveyed from an investor to a homeowner or to a flipper, for example, of real asset 205. At a later time, such as after sale of the real asset at a desired price the financial resource premium, or a portion thereof, may be conveyed or returned back to an investor.

At 255, memory device 230 coupled to and/or operating under the direction of computer processor 250, may generate and/or form a record of materials needed to complete specified modifications to real asset 205. Thus, for example, responsive to obtaining a listing of specified modifications to real asset 205, computer processor 250 may provide a spreadsheet of quantities, such as type and quantity of paint, wallpaper parameters, or parameters of other types of wallcoverings, as well as quantities of tile or other type of floor covering appropriate for re-flooring of real asset 205, and potentially numerous additional materials that may be needed or consumed in performing the specified modifications. Although shown as a spreadsheet in FIG. 2A, a record of materials may be supplied in any format, such as an electronic spreadsheet, an electronic table, or any other convenient and/or easily transmittable format.

At 260, a record of materials may be transmitted to a contracting entity. In particular embodiments, a contracting entity may include a construction clearinghouse, in which listings or other types of records from various sources are received at a central location and then transmitted to one or more construction firms, which may choose to accept, or to bid on particular construction projects. In other embodiments, a record of materials may be transmitted to a particular contracting entity, such as an entity that has been preselected to perform specified modifications to real asset 205. At 265, a contract may be executed with a contracting entity so that the specified modifications can be accomplished.

In particular embodiments, 265 may involve execution of a smart contract, in which generation of a record of materials may bring about formation of a smart or self-executing agreement. For example, based, at least in part, on formation of a record of materials to be transmitted to a particular contacting entity, terms and conditions for completion of modifications involving materials, installation of such materials as part of a contract to modify the real asset may be inserted into an agreement between, for example, an investor and a homeowner without a need for explicit user input. In particular embodiments, a monetary value of a smart contract may correspond to a financial resource premium amount.

In one possible embodiment, just as an illustrative example, a real asset may be estimated to have an as-is value of $200,000, which may be determined via accessing one or more real asset databases. Additionally, a homeowner or a flipper, for example may specify desired customizations and/or modifications that total an allocated budget of $50,000. Further, it may be determined that responsive to the real asset undergoing the desired customizations and/or modifications, the real asset may be valued at, for example, $300,000. Hence, an investor may convey $50,000 to the homeowner of the real asset as a means of accomplishing the desired modifications to the real asset. In an embodiment, responsive to the investor conveying the amount (e.g., $50,000) to the homeowner or flipper of the real asset, the investor may place a lien or other type of encumbrance on the title of the real asset, which may operate to prevent the homeowner or flipper from immediately selling the real asset. Thus, in an embodiment, the financial resource premium operates as an option, which provides a first entity (e.g., an investor) with an opportunity to purchase a portion of the real asset at an agreed-to price and within a specified period of time. In one possible example, a first entity (e.g., an investor) may agree to an as-is price of $200,000 to be purchased within a four-month time window. In an embodiment, the financial resource premium may provide the investor with a right to purchase, for example, one half of the real asset (e.g., a $100,000 stake). However, in other embodiments, the financial resource premium may provide the investor with the right to purchase a different fraction of a real asset, such as 25% of a real asset, 30% of a real asset, 35% of a real asset, 40% of a real asset, and so forth. In other embodiments, a financial resource premium may provide the investor with the right to purchase a fraction of the real asset that is greater than one half, such as 55%, 60%, 65%, 75%, etc. It should be additionally noted, however, that although the present example describes a financial resource premium that is equal to an amount required to perform specified modifications (e.g., $50,000), in other embodiments, a financial resource premium may be less than an amount required to perform specified modifications (e.g., $35,000, $40,000, $45,000, etc.) or may be greater than an amount required to perform specified modifications (e.g., $55,000, $60,000, $65,000, etc.) and claimed subject matter is not limited in this respect.

Continuing with the example, responsive to specified customizations and/or modifications being completed to a real asset, the asset may be offered for sale to a second entity (e.g., a prospective buyer). Thus, responsive to acceptance of an offer to purchase the real asset at an amount that meets or exceeds the value of the real asset (e.g., $300,000) the homeowner may sell the real asset to an investor in a first transaction of two sequential real estate transitions. In such a first transaction, an investor may purchase one half of the real asset's estimated as-is value. Accordingly, in such an instance, an investor may pay a fraction of the as-is value of the real asset (e.g., $100,000) to a homeowner. At such point, the investor owns 50%, for example, of the real asset. Also in such an example, an investor may credit a seller, such as by an amount equal to one-half of the financial resource premium (e.g., $25,000). The first transaction of the two sequential real asset transactions may be summarized below:

TABLE I
Transaction Amount = $200,000 (As-Is Value Of Real Asset)

| | Resulting Seller | Resulting first entity (e.g., |
|---|---|---|
| Payment Description ($) | Position ($) | Investor) Position ($) |
| 50,000 for Selected | ±0 (Monies Paid | −50,000 |
| Modifications | to Contractor) | |
| 100,000 to Seller | +100,000 | −150,000 |

Accordingly, at the close of the first transaction, the seller of the real asset has received $100,000, while the investor has paid $150,000. Further, $50,000 has been allocated to a contractor or clearinghouse so that customizations and/or modifications may be performed. To protect the first entity's (e.g., the investor's) investment, the first entity may record a lien or the type of encumbrance, which prevents the seller from selling the real asset until a second transaction, described below, has been completed.

In the present example, a second transaction involving sale of the real asset to a second entity (e.g., a buyer) for an amount of $300,000, for example, may take place. In such an example, a first fraction (e.g., 50%) of the financial resource premium (e.g., 50% of $50,000 or $25,000) may be conveyed from the seller of the real asset back to the first entity (e.g., the investor). The seller may then receive 50% of the selling price of the real asset (e.g., $150,000), and the first entity (e.g., the investor) may receive the remaining 50%. The second transaction may be summarized below:

TABLE II
Transaction Amount = $300,000 (Value
of Real Asset with Specified Modifications)

| | Resulting Seller | Resulting Investor |
|---|---|---|
| Payment Description ($) | Position ($) | Position ($) |
| 50% of Financial | 75,000 (100,000 − | −125,000 = (−150,000 + |
| Resource Premium | 25,000) | $25,000) |
| ($25,000) to Investor | | |
| 50% of Real Asset value | 225,000 (75,000 + | −125,000 |
| from Buyer to Seller | 150,000) | |
| 50% of Real Asset value | 225,000 | 25,000 = −125,000 + |
| from Buyer to Investor | | 150,000 |

Accordingly, in this example, an initial allocation of the financial resource premium ($50,000) has enabled the homeowner of a real asset to perform specified modifications to the real asset, resulting in the real asset increasing in value from $200,000 to $300,000. Responsive to sale of the real asset for $300,000, the homeowner has received $225,000, and the investor has received $25,000. Of course, this nonlimiting example is but one of numerous embodiments, and claimed subject matter is intended to embrace all such embodiments.

FIG. 2B is a diagram of a user interacting with a graphical user interface of a communications device prior to selection of design aspects of a kitchen of a real asset, according to an embodiment 275. In the embodiment of FIG. 2B, a user, who may correspond to a homeowner or other party, such as an individual who intends to flip the real asset, may interface with a computer-aided design software package, such as described in reference to FIG. 2A. In such a scenario, the computer-aided design software package may display to the user a representation, which may be a video capture or a computer-generated image of, for example, cabinets 277 and subfloor 279. The representation shown in FIG. 2B may correspond to a portion of a structurally sound real asset in which, for example, foundations, roofs, loadbearing walls, subflooring, etc. has been remediated. Accordingly, in the embodiment of FIG. 2B, a number of design aspects have yet to be selected by the user. Via interaction with a computer-aided design software package executing via at least one processor and a memory device of communications device 102, a user may view a computer rendering of various design selections for countertops installed virtually on or over cabinets 277. Such design selections include, for example, countertop materials, finish, texture, and color. Similarly, subfloor 279 may correspond to a structurally sound subfloor, such as a concrete subfloor, in which any structural features, such as significantly-sized in a concrete subfloor, for example, have been filled. Thus, similar to a computer rendering of countertops placed on or over cabinets 277, various flooring types, such as hardwood, engineered and/or laminate materials, carpet, linoleum, etc., may be rendered as being placed on or over subfloor 279.

FIG. 2C is a diagram of a user interacting with a graphical user interface of a communications device after selection of design aspects of a kitchen of a real asset, according to an embodiment 285. In the embodiment of FIG. 2C, a user, who may correspond to a homeowner or other party, such as an individual who intends to flip the real estate asset, is shown as having selected various design options for a kitchen portion of a real asset. Thus, responsive to user selection of countertop materials 287 for installation on or over cabinets 277, the user may be capable of determining whether such selections are appealing and/or whether such selections clash or otherwise appear visually incompatible with other design aspects of, for example, the kitchen portion of the real asset. Similarly, also has shown in FIG. 2C, flooring 289 has been rendered as being disposed on or over subfloor 279, thus allowing the user to determine the visual appeal of such a flooring selection within the context of the kitchen portion, for example, of the real asset.

In particular embodiments, in response to selection of various design aspects of a real asset, such as the design aspects related to the kitchen portion (e.g., FIGS. 2B and 2C) of a real asset, a computer processor, such as computer processor 250 of FIG. 2A, may operate to generate a listing of estimated resources to tailor the real asset in accordance with such selections. Thus, at least in particular embodiments, resources database 235 may include financial resources, which may provide an estimate of costs associated with construction parameters corresponding to customizations and/or modifications specified by, for example, a homeowner or flipper of real asset 205. At 255, memory device 230 coupled to and/or operating under the direction of computer processor 250, may generate and/or form a record of materials needed to complete specified modifications to real asset 205. Thus, for example, responsive to obtaining a listing of specified modifications to real asset 205, computer processor 250 may provide a spreadsheet of quantities, such as type and quantity of paint, wallpaper parameters, or parameters of other types of wallcoverings; quantities of tile or other type of floor covering appropriate for re-flooring of real asset 205, and potentially numerous additional materials that may be needed or consumed in performing the modification specified by the homeowner or the flipper. Although shown as a spreadsheet in FIG. 2A, a record of materials may be supplied in any format, such as an electronic spreadsheet, an electronic table, or any other convenient, easily transmittable format.

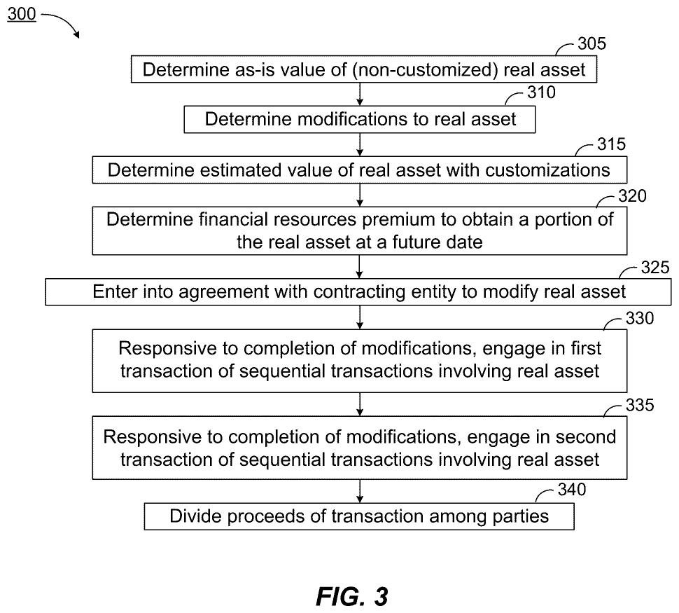

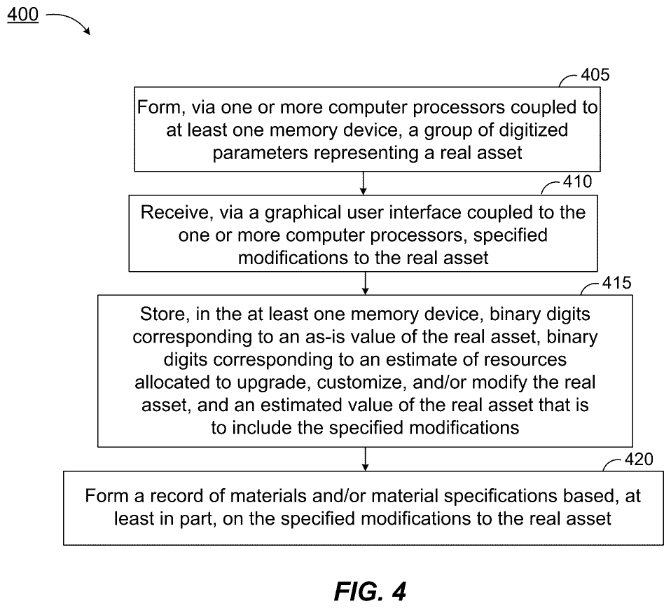

FIG. 3 is a flowchart for a method of customizing and/or modifying a real asset, wherein such customizations/modifications are interlinked with a real asset modification infrastructure, according to an embodiment. It should be noted that the process represented by the flowcharts of FIGS. 3 and 4 may include actions in addition to those depicted in the figure and/or may include actions arranged in an order different than is shown in the figures. The method of FIG. 3 may begin at 305, in which a homeowner or a flipper, investor, or other interested party, for example, may determine the as-is value of a real asset. As mentioned previously herein, an as-is value of real asset may correspond to a real estate asset, such as a single-family home, townhome, condominium, etc., that has not recently undergone customizations and/or modifications. The method may continue at 310, at which a homeowner, interior designer, contractor, or other party, may determine customizations and/or modifications to be performed to a real asset that may be expected to bring about an increase in the value of the real asset. In some instances, 310 may include a homeowner, for example, interacting with a computer, such as a special-purpose computer, which has been programmed to implement a method of computer-aided design. Such a method may enable a homeowner or a flipper, for example, to perform various modifications to a structure of a single-family home, multi-family home, townhome, condominium, etc., which may include modifications to flooring, home layout, new cabinetry, rearrangement of components of the kitchen, upgrades to plumbing fixtures, and a wide variety of additional modifications, and claimed subject matter is not limited in this respect.

At 315, a determination may be made as to the estimated value of the real asset with selected customizations and/or modifications. The determination of 315 may be made in response to interaction with one or more databases, which may access parameters related to expected cost information for various modifications. Such interactions may enable a homeowner to determine per-unit costs of new carpeting or other flooring, new paint, new tile, new fixtures, new cabinetry, and associated labor costs to accomplish the selected modifications. At 320, responsive to compiling or aggregating desired modifications, an estimated value of the real asset with customizations may be computed. 320 may include application of one or more weighting factors, which may operate to increase or decrease resulting value of a real asset based, at least in part, on a type of the desired modification. Thus, as previously described herein, remodeling of the kitchen portion of a real asset may add value to a real asset that is above and beyond material, labor, and design costs associated with the modification. Conversely, addition of certain outside features, such as a swimming pool, may add value to a real asset that is less than material, labor, and design costs associated with the modification.

The method may continue at 325, which may involve a homeowner, for example, entering into an agreement with a contracting entity, to perform customizations and/or modifications to the real asset. 325 may involve a homeowner entering into an agreement with a contractor clearinghouse, for example, which may involve providing a work package to a number of contractors for competitive bidding. 325 may additionally include entering into an agreement with an individual contractor or entering into an agreement with several contractors, who may be selected to perform various types of customizations and/or modifications to a real asset.

At 330, in a first transaction of two sequential transactions involving the real asset, a financial resource premium may be conveyed from an investor to a contractor completing work on the real asset. At such point, as described in Table I, an investor may record a lien or other encumbrance upon the title of the real asset, which may operate to prevent the homeowner from selling the asset prior to completion of a second transaction, such as described at Table II. At the close of the first transaction, the seller retains a fraction of the as-is value of the real asset, such as 50% of the as-is value of the real asset. At 335, a second transaction of two sequential transactions involving the real asset may occur. At 335, the real asset is purchased by a second entity (e.g., a buyer), which may be a separate party from the investor, for example, who pays the desired premium price for the real asset in response to modifications and/or customizations being performed to the real asset. Thus, as summarized in Table II, the second transaction may begin with the seller of, for example, real asset 205 crediting the first entity (e.g., an investor) with one half (or other agreed-upon fraction) of the financial resource premium back to the first entity. In a second portion of a sequential transaction, one half of the selling price of the real asset may be conveyed to the seller, such as at 340, and one half of the selling price of the asset may be conveyed to the first entity (e.g., the investor). Accordingly, as indicated in Table II, at the close of the second sequential transaction, the seller has retained, for example, $225,000, while the investor has retained $25,000. At the close of the second sequential transaction, any lien or other type of encumbrance placed against the title of the real asset may be released, thus permitting a clear transfer of title between the seller of the real asset and the second entity (e.g., the buyer).

In particular embodiments, a third-party manager, such as an escrow agent or title company, may operate to hold or otherwise be at least substantially responsible for holding the deed and other documents relevant to transactions involving real asset 205. The duration or term during which the escrow agent holds or is responsible for managing transactions may encompass at least a portion of the period during which user-selected modifications to the real asset are being performed. Thus, for example, responsive to a user (e.g., a homeowner or a flipper) selecting modifications to a real asset that may be performed within a period of 60 days, the duration or term during which and escrow agent holds or is responsible for managing the transaction may be co-termed with at least a portion of the 60-day period.

FIG. 4 is a flowchart for method for computer-driven real asset customizations and/or modifications which are interlinked with a real asset modification infrastructure, according to an embodiment 400. The method of FIG. 4 may begin at 405, which may include forming, via one or more computer processors coupled to at least one memory device, a group of digitized parameters representing a real asset. In particular embodiments, 405 may involve digitizing parameters of a real asset via a computer-aided design program that facilitates modifications to layout of real asset, materials used in fabrication of a real asset, colors, fit and finish of a real asset, arrangement/layout of a kitchen a real asset, kitchen fixtures, bathroom fixtures, and a wide range of other aspects of real asset, and claimed subject matter is not limited in this respect.

At 410, a user, such as a homeowner, may utilize a graphical user interface to interact with a special-purpose computer to identify and/or select various customizations and/or modifications of a real asset. At 415, a special-purpose computer, for example, may store, such as by way of at least one memory device, binary digits corresponding to an as-is value of the real asset as well as binary digits corresponding to an estimate of resources allocated to modify the real asset. 415 may additionally include storing of an estimated value of the real asset that includes the specified modifications. At 420, a special-purpose computer may form a record of customizations and/or material specifications based, at least in part, on the specified modifications to the real asset.

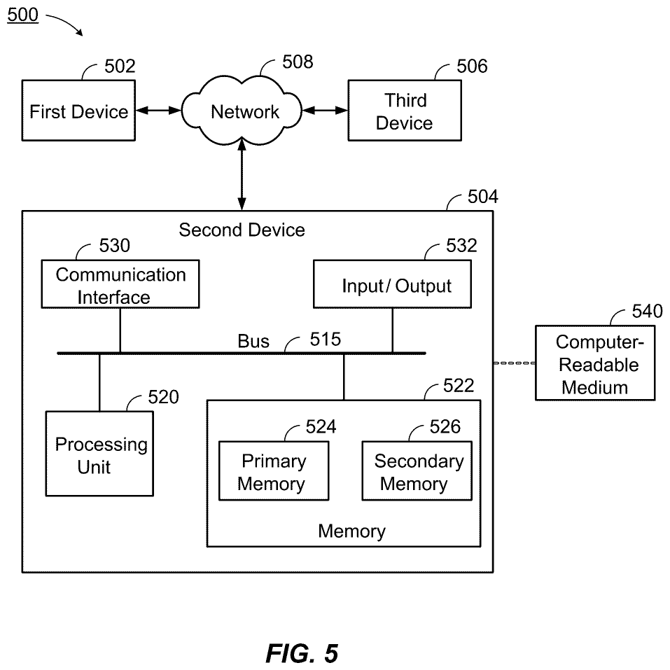

FIG. 5 is a diagram showing a computing environment, according to an embodiment 500. In the embodiment of FIG. 5, first and third devices 502 and 506, which may correspond, for example, to a communications device such as communications device 102, may be capable of rendering a graphical user interface (GUI) for a network device, such as server device 140 of FIG. 1, so that a subscriber utilizing a communications device (e.g., a mobile cellular communications device) may engage in system use. Second device 504 may correspond to computer processor 250 of FIG. 2A. Likewise, in FIG. 5, computing device 502 (‘first device’ in FIG. 5) may interface with second device 504 (‘second device’ in FIG. 5), which may, for example, also comprise features of a client computing device and/or a server computing device, in an embodiment. Processor (e.g., processing device) 520 and memory 522, which may comprise primary memory 524 and secondary memory 526, may communicate by way of a communication interface 530, for example. The term “computing device,” or “computer processor” in the context of the present patent application, refers to a system and/or a device, such as a computing apparatus that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Second device 504, as depicted in FIG. 5, is merely one example, and claimed subject matter is not limited in scope to this particular example.

In FIG. 5, first device 502 may provide one or more sources of executable computer instructions in the form of physical states and/or signals (e.g., stored in memory states), for example. First device 502 may communicate with second device 504 by way of a network connection, such as via network 508, for example. As previously mentioned, a connection, while physical, may be virtual while not necessarily being tangible. Although second device 504 of FIG. 5 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 522 may comprise any non-transitory storage mechanism. Memory 522 may comprise, for example, primary memory 524 and secondary memory 526, additional memory circuits, mechanisms, or combinations thereof may be used. Memory 522 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 522 may comprise one or more articles utilized to store a program of executable computer instructions. For example, processor 520 may fetch executable instructions from memory and proceed to execute the fetched instructions. Memory 522 may also comprise a memory controller for accessing device readable-medium 540 that may carry and/or make accessible digital content, which may include code, and/or instructions, for example, executable by processor 520 and/or some other device, such as a controller, as one example, capable of executing computer instructions, for example. Under direction of processor 520, a non-transitory memory, such as memory cells storing physical states (e.g., memory states), comprising, for example, a program of executable computer instructions, may be executed by processor 520 and able to generate signals to be communicated via a network, for example, as previously described. Generated signals may also be stored in memory, also previously suggested.

Memory 522 may store electronic files and/or electronic documents, such as relating to one or more users, and may also comprise a machine-readable medium that may carry and/or make accessible content, including code and/or instructions, for example, executable by processor 520 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

Processor 520 may comprise one or more circuits, such as digital circuits, to perform at least a portion of a computing procedure and/or process. By way of example, but not limitation, processor 520 may comprise one or more processors, such as controllers, micro-processors, micro-controllers, application specific integrated circuits, digital signal processors, programmable logic devices, field programmable gate arrays, the like, or any combination thereof. In various implementations and/or embodiments, processor 520 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 5 also illustrates second device 504 as including a component 532 operable with input/output devices, and communication bus 515, for example, so that signals and/or states may be appropriately communicated between devices, such as second device 504 and an input device and/or an output device. A user may make use of an input device, such as a computer mouse, stylus, track ball, keyboard, and/or any other similar device capable of receiving user actions and/or motions as input signals. Likewise, for a device having speech to text capability, a user may speak to generate input signals. Likewise, a user may make use of an output device, such as a display, a printer, etc., and/or any other device capable of providing signals and/or generating stimuli for a user, such as visual stimuli, audio stimuli and/or other similar stimuli.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modeled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more communications devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a client computing device and/or a communications device, as well as other types of devices, including between wired and/or wireless devices coupled via a wired and/or wireless network, for example.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a communications device and/or a client computing device in various embodiments. Network devices capable of operating as a client computing device, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a communications device, as well as other types of devices, including between wired and/or wireless devices coupled via a wired and/or wireless network, for example, or any combination thereof. It is noted that the terms, server, server device, server computing device, server computing platform and/or similar terms are used interchangeably.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communications devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

The term electronic file and/or the term electronic document are used throughout this document to refer to a set of stored memory states and/or a set of physical signals associated in a manner so as to thereby, at least logically, form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is may be common. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). As suggested previously, a computing device and/or a networking device may also have a subscriber identity module (SIM) card, which, for example, may comprise a detachable or embedded smart card that is able to store subscription content of a subscriber, and/or is also able to store a contact list. It is noted, as previously mentioned, that a SIM card may also be electronic in the sense that it may simply be sorted in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a communications device application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method for customizing a real asset, comprising:
forming, via one or more computer processors coupled to at least one memory device, a group of digitized parameters representing the real asset;
receiving, via a graphical user interface coupled to the one or more computer processors, specified modifications to the real asset;
storing, in the at least one memory device, binary digits corresponding to an as-is value of the real asset, binary digits corresponding to an estimate of resources allocated to modify the real asset, and an estimated value of the real asset that is to include the specified modifications;
computing, based, at least in part, on the estimate of the resources via the one or more computer processors, an amount of a financial resource premium that permits a first entity to procure the real asset at the as-is value; and
forming a record of materials and/or material specifications based, at least in part, on the specified modifications to the real asset.

2. The method of claim 1, further comprising:
computing a fraction of the amount of the financial resource premium provided to the first entity responsive to a second entity procuring the real asset.

3. The method of claim 1, wherein the group of digitized parameters representing the real asset correspond to construction parameters of the real asset.

4. The method of claim 3, wherein the construction parameters of the real asset correspond to at least one of: a floor plan, a type of flooring in one or more sections of the real asset, a roof type, cabinetry parameters, installed appliance parameters, countertop parameters, outside landscaping parameters, kitchen fixture parameters, bathroom fixture parameters, interior wall coloring, and exterior coloring.

5. The method of claim 1, wherein the real asset corresponds to a real estate asset.

6. The method of claim 1, wherein the digitized parameters correspond to one or more computer-aided design files.

7. The method of claim 1, further comprising:
transmitting the record of materials and/or material specifications to a contracting entity to modify the real asset in accordance with the specified modifications.

8. The method of claim 1, wherein computing, based, at least in part, on the estimate of the resources further comprises:
initiating a smart contract for an amount based, at least in part, on the amount of the financial resource premium amount.

9. The method of claim 8, wherein the amount of the smart contract corresponds to the financial resource premium amount.

10. The method of claim 1, wherein the graphical user interface coupled to the one or more computer processors comprises:
an application program interface operating on a mobile communications device.

11. The method of claim 1, wherein the first entity corresponds to a real asset flipper.

12. A system, comprising:
one or more computer processors coupled to at least one memory device to form a group of digitized parameters to represent a real asset;
a graphical user interface, coupled to the one or more computer processors, to permit a user to specify one or more modifications to the real asset, wherein
the at least one memory device is to store binary digits corresponding to:
an as-is value of the real asset,
an estimate of resources allocated to modify the real asset and
an estimated value of the real asset that is to include the specified modifications;
and wherein the one or more computer processors is to compute based, at least in part, on the estimate of the resources, a financial resource premium that permits a first entity to procure the real asset at the as-is value, and wherein the one or more computer processors is additionally to form a record of materials and/or material specifications based, at least in part, on the specified modifications to the real asset.

13. The system of claim 12, wherein the graphical user interface operates to present a plurality of options for user-selectable material parameters and/or material specifications to the user via an application programming interface operating on a mobile cellular device.

14. The system of claim 13, wherein the graphical user interface is to interact with a computer-aided design module, which operates to model of a certain aspects of the real asset.

15. The system of claim 14, wherein the one or more computer processors coupled to the at least one memory device is additionally to:
generate, without user input, a listing of material specifications and/or contractor work descriptions responsive to communicating with the computer-aided design module.

16. The system of claim 14, wherein the financial resource premium is based, at least in part, on output signals from the computer-aided design module.

17. An article comprising:
a non-transitory storage medium having computer-readable instructions encoded thereon, which, when executed by a processor coupled to a memory device, are operable to:
form, via one or more computer processors coupled to at least one memory device, a group of digitized parameters representing a real asset;
obtain, via a graphical user interface coupled to the one or more computer processors, specified modifications to the real asset;
store, in the at least one memory device, binary digits corresponding to an as-is value of the real asset, binary digits corresponding to an estimate of resources allocated to modify the real asset in accordance with predetermined modifications, and an estimated value of the real asset that is to include the specified modifications;
compute, based, at least in part, on the estimate of the resources via the one or more computer processors, an amount of a financial resource premium that permits a first entity to procure the real asset at the as-is value; and
form a record of materials and/or material specifications based, at least in part, on the specified modifications to the real asset.

18. The article of claim 17, wherein the computer-readable instructions are additionally operable to:
compute a fraction of the amount of the financial resource premium provided to the first entity responsive to a second entity procuring the real asset.

19. The article of claim 17, wherein the group of digitized parameters representing the real asset correspond to construction parameters of the real asset.

20. The article of claim 19, wherein the construction parameters of the real asset correspond to at least one of: a floor plan, a type of flooring in one or more sections of the real asset, a roof type, cabinetry parameters, installed appliance parameters, countertop parameters, outside landscaping parameters, kitchen fixture parameters, bathroom fixture parameters, interior wall coloring, and exterior coloring.

21. The article of claim 20, wherein the instructions are additionally operable to: form a record of materials and/or material specifications, and to
transmit the record of the materials and/or the material specifications to a contracting entity.
